(19) United States
(12) Patent Application Publication
(10) Pub. No.: US 2025/0390165 A1
(43) Pub. Date: Dec. 25, 2025

(54) METHOD AND SYSTEM FOR PROVIDING VIRTUAL LOCOMOTION CONTROL

(71) Applicant: SAMSUNG ELECTRONICS CO., LTD., Suwon-si (KR)

(72) Inventors: Aditya RAJ, Noida (IN); Swastik MISHRA, Noida (IN); Shashank AGRAWAL, Noida (IN)

(73) Assignee: SAMSUNG ELECTRONICS CO., LTD., Suwon-si (KR)

(21) Appl. No.: 19/268,162

(22) Filed: Jul. 14, 2025

Related U.S. Application Data
(63) Continuation of application No. PCT/KR2025/004092, filed on Mar. 28, 2025.

(30) Foreign Application Priority Data
Jun. 25, 2024 (IN) 202411048591

(51) Int. Cl. G06F 3/01; G06T 3/16; G06T 7/73; G06T 19/00; G06V 20/64

(52) U.S. Cl. CPC G06F 3/011; G06T 3/16; G06T 7/74; G06T 19/00; G06V 20/64; G06F 2203/012; G06T 2200/24

(57) ABSTRACT

A method and a system for providing virtual locomotion control to a user during a virtual reality (VR) session. The method includes: capturing one or more frames of a user physical space; determining a safe zone within the user physical space based on the one or more frames; generating at least one locomotion control scheme for the user based on the safe zone, at least one characteristic associated with the user, and the VR session; and providing the virtual locomotion control to the user based on the at least one locomotion control scheme.

### CROSS-REFERENCE TO RELATED APPLICATIONS

This application is a bypass continuation application of International Application No. PCT/KR2025/004092, filed on Mar. 28, 2025, which claims priority to Patent Application Nos. 202411048591, filed on Jun. 25, 2024, in the Indian Intellectual Property Office, the disclosures of which are incorporated by reference herein in their entireties.

### BACKGROUND

### 1. Field

The present disclosure relates to virtual reality, and more particularly relates to a method and a system for providing virtual locomotion control to a user during a virtual reality session.

### 2. Description of Related Art

Virtual reality (VR) is a unified concept of augmented reality and mixed reality, starting from a virtual environment for generating simulated reality using a computer and a related technology, and is a leading-edge technology for improving a perception of a user by relying on necessary devices. With the development of artificial intelligence and computer vision image processing technology, virtual reality vision simulation technology has been gradually applied to three-dimensional sessions or games.

VR technology has the main characteristic of people feeling as if they are personally in a virtual reality scene, and a comprehensive promotion of the technology may lead users to feel an illusion of a virtual world from a visual and auditory perspective, also may also lead a sense of the user to enter a VR system and use the body and mind to imagine a current environment. The “virtual reality session or game,” is an industrial extension based on computer technology and virtual reality devices. In this regard, the experience may be shuttled to the future through the interactive virtual scene. The application of VR in the game industry is mainly embodied in a game perception experience, and the user is immersed in a new situation experience and may freely interact with objects in a virtual space.

Currently, there are three primary categories of VR simulations. One of the three categories may include a non-immersive virtual reality which refers to a virtual experience through the computer where the user can control some characters or activities within a software, but the environment is not directly interacting with the user. For example, a video game where the user may control a character without direct interaction.

Second is a semi-immersive virtual which may give the user a perception of being in a different reality when the user focuses on a digital image, but also allow the user to remain connected to the physical surroundings associated with the user. Semi-immersive technology provides realism through three-dimensional graphics, which is known as vertical reality depth.

A third category is a fully immersive VR that provides a virtual tour from sound to sight. This type of VR is completely confined and away from the physical surroundings. This VR is commonly adapted for gaming and entertainment. In a fully immersive VR, the user may feel a physical presence in the virtual world.

In recent years, with the advent of low-cost head-mounted displays (HMD), immersive virtual reality devices have become popular among users. However, in the existing technologies, in a VR session, the user using the HMD may only see frames in a virtual scene during the VR session. More particularly, the user may enter a physical area of the user during the VR session, and the user may not be able to see the objects surrounding the user when wearing the HMD device. Therefore, the objects may be touched during the VR session, and may also lead to a collision with physical people or objects nearby. This may cause harm to the property and/or life of the user, or the people present nearby.

Further, existing technologies may have disadvantages in specific scenarios, such as where multiple VR sessions are occurring simultaneously in the same physical space. In such scenarios, the users may find it challenging to fully immerse themselves due to the limited available physical area. For instance, VR sessions involving activities like running or similar movements require substantial space for proper immersion.

Furthermore, in the existing technologies, users with disabilities, such as those in wheelchairs, may face difficulties during VR sessions due to the lack of specialized gestures that enable seamless immersion.

To overcome the above-discussed drawbacks, VR hardware devices came into existence which may enable the user to engage in VR sessions in a constrained space. The VR hardware devices are products that facilitate the user to immerse in the VR session.

Some examples of these devices may include but are not limited to a VR treadmill, a VR mat, Omni One, a three-dimensional (3D) mouse, optical trackers, wired gloves, motion controllers, bodysuits, and even smelling devices, etc.

However, these VR hardware devices are very costly and unaffordable for many users. Further, the VR hardware devices are physically configured with the body of the user in the constrained space. Due to this, the user may find it difficult to move after a long time. Further, if more than one user wants to engage in the VR session, then each user needs to buy a separate setup to engage in the VR session, which may increase the cost for the users.

Moreover, as the VR hardware devices are installed in the constrained space, a collision may occur between the users. In this regard, existing technologies do not allow multiple users to engage in the VR session simultaneously.

To overcome the drawbacks mentioned above, virtual solutions came into existence, which may prevent the user from falling while the user is immersed in the VR session by mapping an obstruction present in a real world to the virtual obstruction in the VR session, thereby alerting the user in the VR session in case of any physical obstruction and recommends stopping any further movements in the real world.

Another solution is a teleportation which may allow the user or the objects to move from one location to another in the VR session. In this solution, the user may specify a destination in the VR session by pointing to the location using a handheld motion-tracked controller, and then initiating a teleportation action, enabling the user/objects to move at the specified destination.

However, teleportation results in motion sickness due to an unnatural sudden change in surroundings. This may also lead to disorientation if head rotation shifts during transport. Further, the user may overshoot the virtual target location, resulting in multiple attempts to get into the right position. Furthermore, the user may accidentally teleport into a wall or other virtual object, which breaks a sense of presence.

In related art technologies, users cannot directly correlate real-world movements with movements in the VR session. This disconnect can cause severe motion sickness, thereby degrading the user experience.

Further, in the related art technologies, collisions or falls may be prevented fully, as there is a human tendency to relate its motion to the virtual object motion which may lead the user to follow the actual activity being performed in the virtual environment.

Further, the user's posture for performing activities may not be fixed and the user may move around risking collision or a fall. For example, the user moving a leg in one position to perform a running activity in the VR session may start running in the real world causing collision with nearby objects or a fall.

Furthermore, the related art technologies are restricted to the VR sessions having provided limited options for body-related motion and do not consider, user-safe play zones or real-time obstructions in the user play area.

Therefore, there is a need to overcome the above-discussed limitations and provide a method and system for providing virtual locomotion control to the user during the VR session efficiently and cost-effectively.

### SUMMARY

According to an aspect of the disclosure, a method of providing virtual locomotion control to a user during a virtual reality (VR) session, includes: capturing one or more frames of a user physical space; determining a safe zone within the user physical space based on the one or more frames; generating at least one locomotion control scheme for the user based on the safe zone, at least one characteristic associated with the user, and the VR session; and providing the virtual locomotion control to the user based on the at least one locomotion control scheme.

According to an aspect of the disclosure, a system for providing virtual locomotion control to a user during a virtual reality (VR) session, includes: a sensor; a memory storing one or more instructions; and at least one processor configured to execute the one or more instructions, wherein the one or more instructions, when executed by the at least one processor, cause the system to: obtain, through the sensor, one or more frames of a user physical space; determine a safe zone within the user physical space; generate at least one locomotion control scheme for the user based on the safe zone, at least one characteristic associated with the user, and the VR session; and provide the virtual locomotion control to the user based on the at least one locomotion control scheme.

According to an aspect of the disclosure, a non-transitory computer readable medium has instructions stored therein, which when executed by at least one processor cause the at least one processor to execute a method of providing virtual locomotion control to a user during a virtual reality (VR) session, the method including: capturing one or more frames of a user physical space; determining a safe zone within the user physical space based on the one or more frames; generating at least one locomotion control scheme for the user based on the safe zone, at least one characteristic associated with the user, and the VR session; and providing the virtual locomotion control to the user based on the at least one locomotion control scheme.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 illustrates an exemplary representation of a system for providing a virtual locomotion control to a user during a Virtual Reality (VR) session;

FIG. 2 illustrates an exploded view of an exemplary VR headset, in accordance with one or more embodiments of the present disclosure;

FIG. 3 illustrates an example representation of a plurality of modules, in accordance with one or more embodiments of the present disclosure;

FIG. 4 illustrates a flowchart depicting an exemplary method for providing the virtual locomotion control to the user during the VR session, in accordance with one or more embodiments of the present disclosure;

FIG. 5 illustrates a flowchart depicting a method for determining a safe zone (SZ) within a user physical space for immersing in the VR session, in accordance with one or more embodiments of the present disclosure;

FIGS. 6A and 6B illustrate exemplary representations of the determined safe zone based on a movement of the user while the user is immersed in the VR session, in accordance with one or more embodiments of the present disclosure;

FIG. 6C illustrates an exemplary representation of the VR session selected by the user which requires heavy movement while the user is immersed in the VR session, in accordance with one or more embodiments of the present disclosure;

FIG. 6D illustrates an exemplary representation of the determined safe zone based on the VR session as illustrated in FIG. 6C, in accordance with one or more embodiments of the present disclosure;

FIGS. 6E and 6F illustrate exemplary representations of the VR sessions selected by the user which require light movement while the user is immersed in the VR session, in accordance with one or more embodiments of the present disclosure;

FIG. 6G illustrates an exemplary representation of the determined safe zone based on the VR sessions as illustrated in FIGS. 6E and 6F, in accordance with one or more embodiments of the present disclosure;

FIG. 7 illustrates a flowchart depicting the method including further operations of FIG. 4 for providing the virtual locomotion control to the user during the VR session, in accordance with one or more embodiments of the present disclosure;

FIG. 8 illustrates a flowchart depicting a method for determining an activity of the user, in accordance with one or more embodiments of the present disclosure;

FIG. 9 illustrates a flowchart depicting a method for generating at least one locomotion control scheme for the user, in accordance with one or more embodiments of the present disclosure;

FIG. 10A illustrates an exemplary representation of a selection of the at least one generated locomotion control scheme, in accordance with one or more embodiments of the present disclosure;

FIGS. 10B and 10C illustrate exemplary representations of the movement of the user in the user physical space and a corresponding movement of the user in the VR session by utilizing the at least one generated locomotion control scheme, in accordance with one or more embodiments of the present disclosure;

FIGS. 11A and 11B illustrate exemplary representations of the movement of the user in the user physical space and a corresponding movement in the VR session, in accordance with one or more embodiments of the present disclosure.

FIG. 12A illustrates an exemplary representation of a field of view (FOV) of the user while the user is immersed in the VR session, in accordance with one or more embodiments of the present disclosure;

FIG. 12B illustrates an exemplary segmentation of one or more first components in the FOV of the user while the user is immersed in the VR session, in accordance with one or more embodiments of the present disclosure;

FIG. 12C illustrates an exemplary segmentation of one or more first components in the FOV of the user while the user is immersed in the VR session, in accordance with one or more embodiments of the present disclosure;

FIG. 13 illustrates a method for overlaying the determined safe zone and the at least one generated locomotion control scheme in the FOV of the user, in accordance with one or more embodiments of the present disclosure;

FIG. 14 illustrates an exemplary representation of the overlaying of the determined safe zone and the at least one generated locomotion control scheme, in accordance with one or more embodiments of the present disclosure;

FIG. 15A illustrates an exemplary representation of a user interface depicting the user crossing the determined safe zone, in accordance with one or more embodiments of the present disclosure;

FIG. 15B illustrates an exemplary representation of the user interface depicting a generation of an alert notification when the user crosses a boundary of the determined safe zone; and

FIG. 16 illustrates an exemplary representation of the user physical space in which two users are immersed in different VR sessions, in accordance with one or more embodiments of the present disclosure.

### DETAILED DESCRIPTION

For the purpose of promoting an understanding of the principles of the disclosure, reference will now be made to the one or more embodiments and specific language will be used to describe the same. Although illustrative implementations of the embodiments of the present disclosure are described below, the present disclosure may be implemented using any number of techniques, whether currently known or in existence. The present disclosure is not necessarily limited to the illustrative implementations, drawings, and techniques illustrated below, including the exemplary design and implementation illustrated and described herein, but may be modified within the scope of the present disclosure.

Further, the drawings are illustrated for simplicity and may not have necessarily been drawn to scale. For example, the flow charts illustrate the method in terms of the most prominent operations involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

The embodiments herein and the various features and details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the one or more embodiments described herein are not necessarily mutually exclusive, as one or more embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

As used herein, the expressions “at least one of a, b or c” and “at least one of a, b and c” indicate “only a,” “only b,” “only c,” “both a and b,” “both a and c,” “both b and c,” and “all of a, b, and c.”

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

The various actions, acts, blocks, steps, or the like in the flow diagrams may be performed in the order presented, in a different order, or simultaneously. Further, in one or more embodiments, some of the actions, acts, blocks, steps, or the like may be omitted, added, modified, skipped, or the like without departing from the scope of the disclosure.

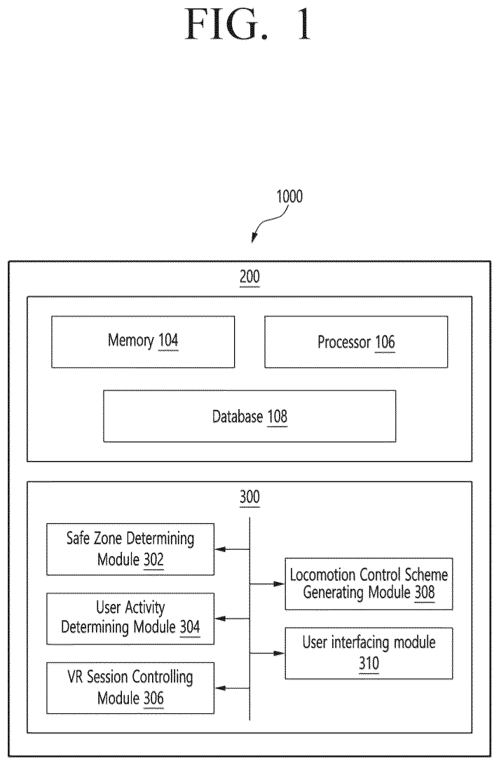

FIG. 1 illustrates an exemplary representation of a system 1000 for providing a virtual locomotion control to a user during a Virtual Reality (VR) session, in accordance with one or more embodiments of the present disclosure. In an example, the virtual locomotion control herein refers to locomotion that may be performed by the user in a controlled manner while the user is immersed in the VR session.

Further, the VR session herein refers to a session during which the user may be immersed in a three-dimensional (3D) virtual environment and may interact with objects or entities. The VR session herein may also interchangeably be termed as a VR game within the scope of the present disclosure. The VR session may include but is not limited to a type of VR session, VR session controls, and one or more actions required for the VR session.

The system 1000 may include but is not limited to, a virtual reality (VR) wearable device 200 or other user equipment. The VR wearable device 200 may include a memory 104, a processor 106 communicatively coupled with the memory 104, a database 108, and a plurality of modules 300.

In one or more embodiments of the present disclosure, the VR wearable device 200 is a VR headset 200 that is adapted to be mounted over a head of the user.

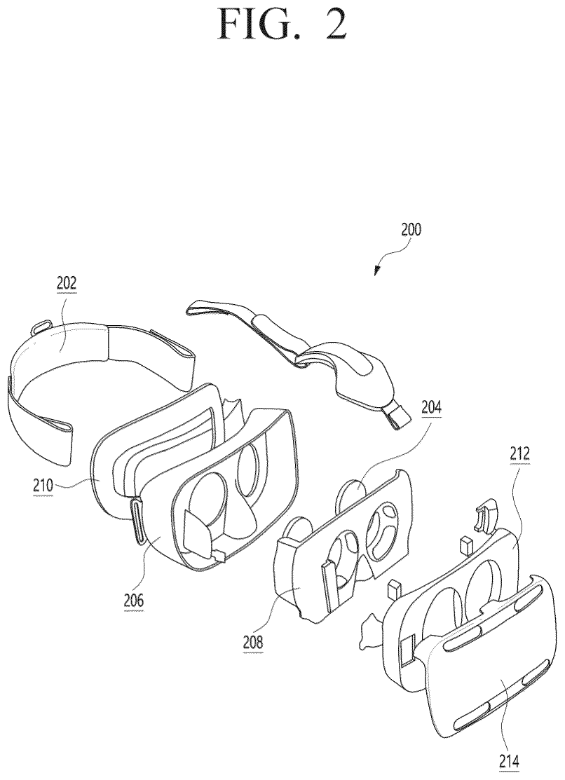

FIG. 2 illustrates an exploded view of an exemplary VR headset 200, in accordance with one or more embodiments of the present disclosure. The VR headset 200 may include but is not limited to an adjustable headband 202, an eyesight correction unit 204, a connection interface unit 206, a motion tracking unit 208, a head-mountable device (HMD) 210, lens mounts 212, and a cover 214.

In one or more embodiments of the present disclosure, the memory 104 may be configured to store data and one or more instructions executable by the processor 106. In one or more embodiments, the memory 104 may be provided within the VR wearable device 200. In one or more embodiments, the memory 104 may be provided via a cloud-based unit. In one or more embodiments, the memory 104 may communicate with the processor 106 via a bus within the system 1000. In one or more embodiments, the memory 104 may be located remotely from the processor 106 and may be in communication with the processor 106 via a network. The memory 104 may include, but is not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 104 may include a cache or random-access memory for the processor 106. In alternative examples, the memory 104 is separate from the processor 106, such as a cache memory of a processor, the system memory, or other memory. The memory 104 may be an external storage device or database 108 for storing data. The memory 104 may be operable to store instructions executable by the processor 106. The functions, acts, or tasks illustrated in the figures or described may be performed by the programmed processor 106 for executing the instructions stored in the memory 104. The functions, acts, or tasks are independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

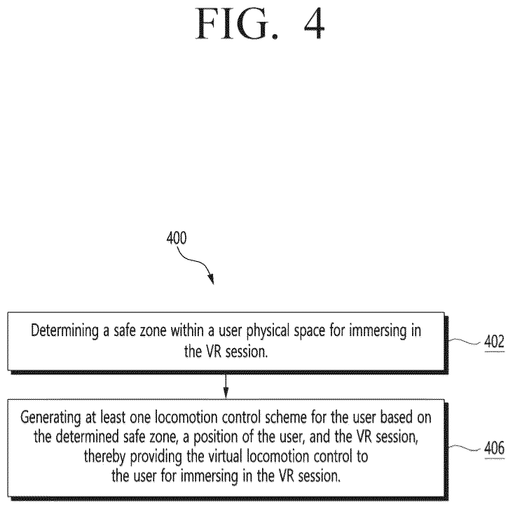

In one or more embodiments, the plurality of modules 300 may be included within the memory 104. The memory 104 may further include the database 108 to store data. The plurality of modules 300 may include the one or more instructions that may be executed to cause the system 1000, in particular, the processor 106 of the system 1000, to execute the one or more instructions, via the plurality of modules 300, for performing the operations of the present disclosure. For instance, the plurality of modules 300 may be configured to perform the operations disclosed in FIGS. 4, 5, and FIGS. 7-9 and FIG. 13.

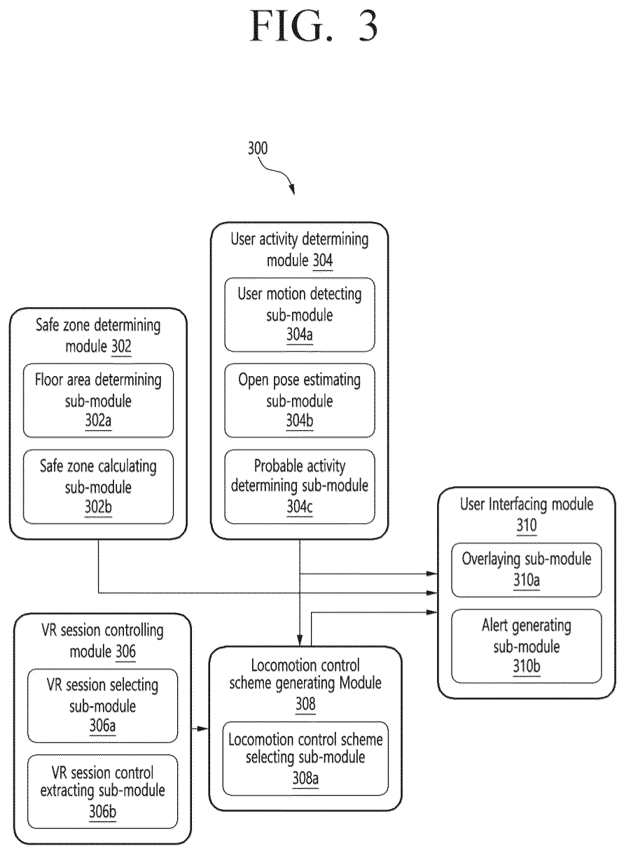

FIG. 3 illustrates an example representation of the plurality of modules 300, in accordance with one or more embodiments of the present disclosure. In one or more embodiments, the plurality of modules 300 includes a safe zone determining module 302, a user activity determining module 304, a VR session controlling module 306, a locomotion control scheme generating module 308, and a user interfacing (UI) module 310.

The safe zone determining module 302 is configured to determine a safe zone (SZ) for the user within a user physical space for immersing in the VR session. The safe zone determining module 302 may include a floor area determining sub-module 302a that may be configured to determine a floor area within the user physical space. The safe zone determining module 302 includes a safe zone calculating sub-module 302b that may be configured to calculate the safe zone based on the determined safe zone, characteristics associated with the user, and the VR session. The characteristics associated with the user may include at least one of, a position of the user and a posture of the user. The user activity determining module 304 is configured to determine an activity of the user. The user activity determining module 304 may include a user motion detecting sub-module 304a that is configured to detect a plurality of motions of the user. The user activity determining module 304 may further include an open pose estimating sub-module 304b that may be configured to estimate one or more open poses of the user based on the detection of the plurality of the motions. The user activity determining module 304 may further include a probable activity estimating sub-module 304c to predict a movement/activity of the user in an upcoming timestamp based on the estimated one or more poses. The VR session controlling module 306 is configured to control the VR session based on the preferences of the user. The VR session controlling module 306 may include a VR session selecting sub-module 306a that is configured to select the VR session. The VR session controlling module 306 may further include a VR session control extracting sub-module 306b that is configured to extract one or more possible locomotion for the VR session. The locomotion control scheme generating module 308 is configured to generate a list of locomotion control schemes (LCs). The locomotion control scheme generating module 308 may include a locomotion control scheme selecting sub-module 308a that may be configured to select the at least one generated locomotion control scheme from the list of locomotion control schemes (LCs). The user interfacing (UI) module 310 may be configured to provide a training interface for the user to sync motion between the virtual locomotion control and a VR session control. The user interfacing (UI) module 310 may include an overlaying sub-module 310a that may be configured to overlay the determined safe zone and the at least one generated locomotion control scheme in a field of view (FOV) of the user. The user interfacing (UI) module 310 may further include an alert notification generating sub-module 310b to generate an alert notification when the user crosses a boundary of the determined safe zone.

Further, a detailed explanation of various functions of the system 1000, the processor 106 and/or the plurality of modules 300 may be explained in view of FIGS. 4-16.

FIG. 4 illustrates a flowchart depicting an exemplary method for providing the virtual locomotion control to the user during the VR session, in accordance with one or more embodiments of the present disclosure. The method 400 may be a computer-implemented method executed.

In an exemplary embodiment, the user may be allowed to control the VR session. The VR session may be controlled, via the VR session controlling module 306, based on the preferences of the user or automatically. The user may choose or customize various settings of the VR session.

In one or more embodiments, the VR session herein refers to a VR environment or a VR game that is selected, via the VR session selecting sub-module 306a, by the user.

In one or more embodiments, the one or more possible locomotion options are extracted, via the VR session control extracting sub-module 306b, for the user based on the VR session. The one or more possible locomotion options are extracted by utilizing an Application Programming Interface (API) of the VR session. In an exemplary embodiment, the user may customize the one or more possible locomotion for the VR session.

The “API” herein refers to a set of rules or protocols that enables the plurality of modules 300 to communicate with each other to exchange data, features, and functionality. The API may include an external API which may include a communication library, a movement library, a switch library, and an audio library. The API may further include an internal API that may include a character controller, a behavior, a collision controller, a white cane controller, a collision object, and a connection library.

In an exemplary embodiment, the one or more possible locomotion options for the VR session are illustrated in Table 1 below:

TABLE 1

| | Degree of | | |
|---|---|---|---|
| | Freedom | | Possible Locomotion |
| Controls | (DOF) | Control mechanism | Options |
| Swing | 6 | SwirlKey + physical | Hitting ball |
| | | movement | |
| Run | 3 | X + leg movement | Running |
| Move up | 2 | Y + no physical mov | Catching ball |
| | | ement | |
| Move down | 3 | A/B | Throwing ball |
| Move left | 2 | Right | Walking |
| Move right | 2 | Left | Jump |
| Throttle | 1 | A/B | Speeding effect |
| Trigger | 1 | Right | Projectile |
| Brake | 1 | Left | Stop |

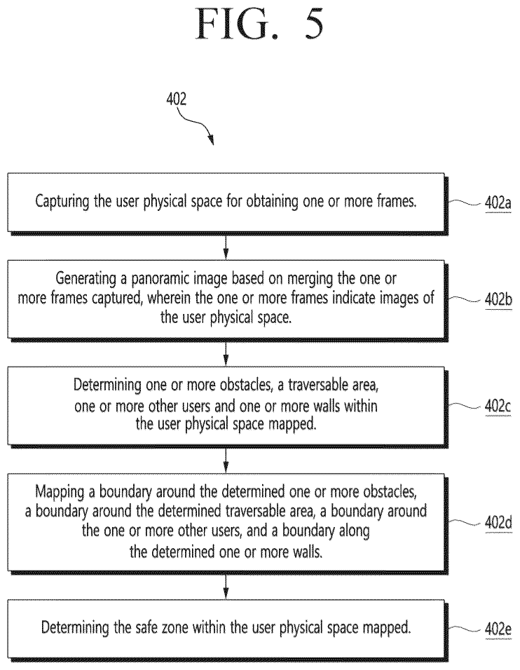

The method 400 begins with operation 402 which may include determining, via the safe zone determining module 302, the safe zone (SZ) within the user physical space for immersing in the VR session. For example, the “user physical space” may refer to the actual, real-world environment where the user is situated while engaging in the VR session. The user physical space may be a room in the user's home, an office, or any other location where the user is currently present. The user physical space may accommodate the user's movements and activities to ensure an immersive and comfortable VR experience. In one or more embodiments, the determination of the safe zone (SZ) is explained in conjunction with FIG. 5.

FIG. 5 illustrates a flowchart depicting an operation 402 for determining the safe zone (SZ) within the user physical space for immersing in the VR session, in accordance with one or more embodiments of the present disclosure. At sub-operation 402a, the operation 402 may include capturing the user physical space by obtaining one or more frames. In one or more embodiments, the one or more frames may include videos or images of the user physical space. The one or more frames indicate images of the user physical space.

In one or more embodiments, the images are captured by locating a capturing unit in a predetermined location of the user physical space. The user may be instructed or asked to stand in about a centre of the user physical space and hold the capturing unit at a chest position to capture the user physical space. In an exemplary embodiment, the capturing unit may be the VR wearable device 200 or installed in the VR wearable device 200. In one or more embodiments, the capturing unit may capture the user physical space from any position of the user physical space.

However, in another exemplary embodiment, the capturing unit may include one of a smartphone, camera, a light detection and ranging (LiDAR) sensor, a sonic sensor, or the like.

In an exemplary embodiment, the user may be instructed or asked to tilt the capturing unit at a predetermined angle to capture the user physical space from a plurality of angles. The user may be instructed to tilt the capturing unit by about 45° clockwise to capture the user physical space from the plurality of angles.

Referring to FIG. 5, at sub-operation 402b, the operation 402 may include generating a panoramic image based on merging the one or more frames captured.

In the embodiment, the floor area of the user physical space may be determined, via the floor area determining sub-module 302a, based on the user physical space mapped.

Further, at sub-operation 402c, the operation 402 may include determining one or more obstacles, one or more other users in the vicinity of the user, a traversable area, and one or more walls within the mapped user physical space. The one or more other users may include other users present in the user physical space in the vicinity of the user who are immersed in the VR session. In an exemplary embodiment, the present disclosure utilizes an object detection architecture for determining the one or more obstacles and the one or more walls.

At operation 402d, the operation 402 may include mapping a boundary around the determined one or more obstacles, a boundary of the one or more other users, a boundary around the determined traversable area, and a boundary along the determined one or more walls.

At sub-operation 402e, the operation 402 may include determining or calculating the safe zone (SZ), via the safe zone calculating sub-module 302b, within the user physical space. In an exemplary embodiment, the traversable area is the determined safe zone (SZ) in the user physical space for immersing in the VR session. In one or more embodiments, the user physical space is determined by the panoramic image captured by the user.

In one or more embodiments of the present disclosure, the user may also calculate the distance of one or more obstacles from the position of the user. The user is then allowed to input the calculated distance, thereby determining the safe zone (SZ) based on the distance received as the user input.

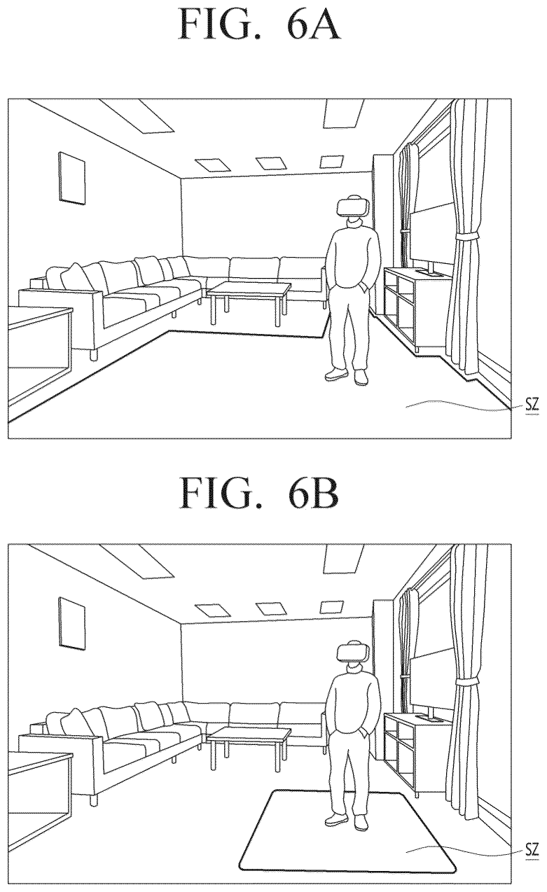

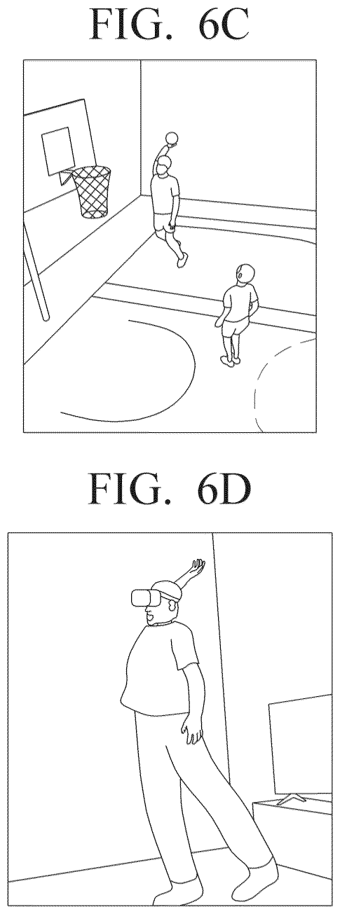

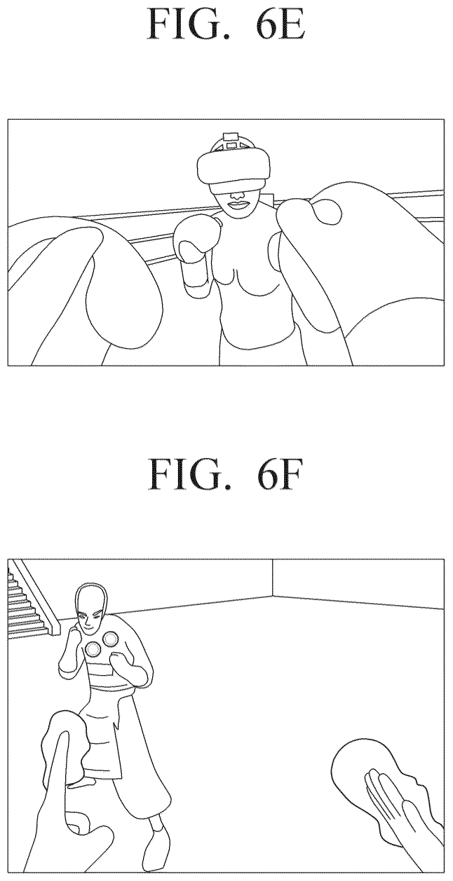

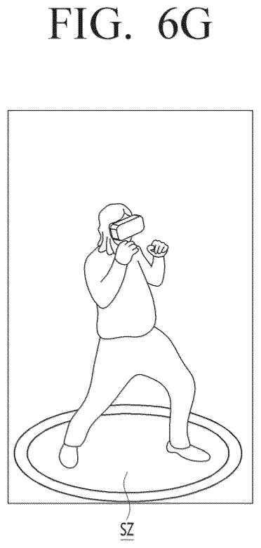

FIGS. 6A and 6B illustrate exemplary representations of the determined safe zone (SZ) based on the movement of the user while the user is immersed in the VR session, in accordance with one or more embodiments of the present disclosure. More particularly, FIG. 6A illustrates an exemplary representation of the determined safe zone (SZ) with the boundary (B) when the user requires heavy movement while the user is immersed in the VR session. FIG. 6B illustrates an exemplary representation of the determined safe zone (SZ) with the boundary when the user requires light movement while the user is immersed in the VR session.

FIG. 6C illustrates an exemplary representation of the VR session selected by the user which requires heavy movement while the user is immersed in the VR session, in accordance with one or more embodiments of the present disclosure. In an exemplary embodiment, the VR session is basketball. FIG. 6D illustrates an exemplary representation of the determined safe zone (SZ) based on the VR session as illustrated in FIG. 6C, in accordance with one or more embodiments of the present disclosure.

FIGS. 6E and 6F illustrate exemplary representations of the VR session selected by the user which requires light movement while the user is immersed in the VR session, in accordance with one or more embodiments of the present disclosure. In an exemplary embodiment, the VR sessions are boxing and karate. FIG. 6G illustrates an exemplary representation of the determined safe zone (SZ) based on the VR sessions as illustrated in FIGS. 6E and 6F, in accordance with one or more embodiments of the present disclosure.

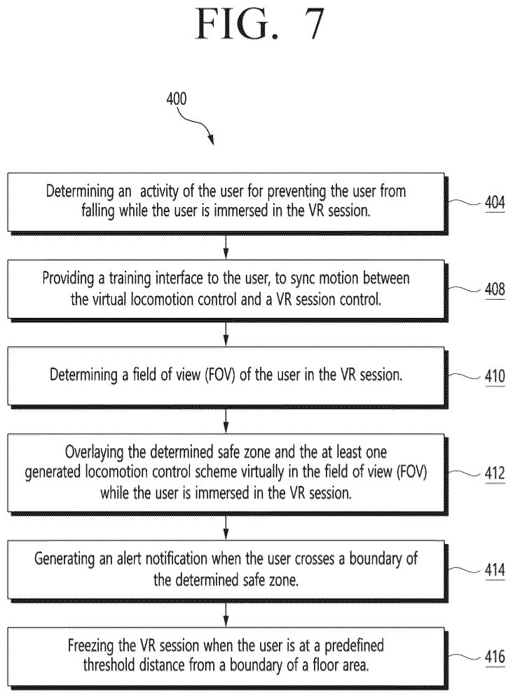

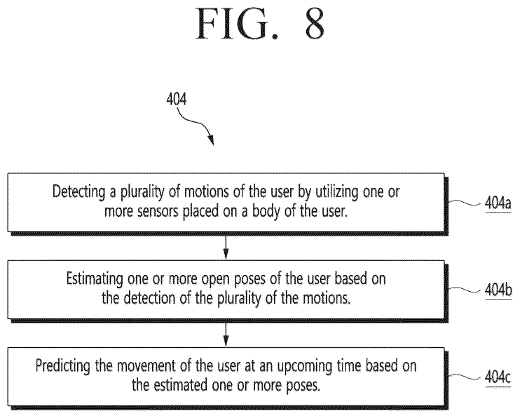

FIG. 7 illustrates a flowchart depicting the method 400 including further operations of FIG. 4 for providing the virtual locomotion control to the user during the VR session, in accordance with one or more embodiments of the present disclosure. At operation 404, the method 400 may include determining, via the user activity determining module 304, the activity of the user for preventing the user from falling while the user is immersed in the VR session. In one or more embodiments, the determination of the activity of the user is discussed in conjunction with FIG. 8.

FIG. 8 illustrates a flowchart depicting a operation 404 for determining the activity of the user, in accordance with one or more embodiments of the present disclosure. At sub-operation 404a, the operation 404 may include detecting, via the user motion detecting sub-module 304a, the plurality of motions of the user by utilizing one or more sensors placed on a body of the user.

In an exemplary embodiment of the present disclosure, the one or more sensors may include a first sensor that is installed in the VR wearable device 200 for detecting neck-to-head movement of the user. The one or more sensors may further include a second sensor installed in one or more handheld motion-tracked controllers for detecting the movement of the user from a shoulder joint to the fingers of the user. Further, the one or more sensors may include a third sensor installed in a lower body by utilizing the smartphone or any other device for detecting the movement of the user from the waist to the toes of the user.

Again, referring to FIG. 8, at sub-operation 404b, the operation 404 may include estimating, via the open pose estimating sub-module 304b, the one or more open poses of the user based on the detection of the plurality of the motions. In an illustrated embodiment, the one or more open poses indicate a movement of the upper body of the user. The one or more open poses of the body may be generated at each instant to track a change in a posture of the user for predicting the movement in an upcoming time, and to track the posture, specifically a current posture of the user at any instant. In one or more embodiments, specific key points of a human body are used to identify the user's current posture. The one or more open poses may be estimated using a network architecture that maps an image of the user. This network architecture is trained via an L2 loss function, and subsequently, the open poses are estimated based on the identified key points of the user.

At sub-operation 404c, the operation 404 may include predicting, via the probable activity estimating sub-module 304c, the movement of the user at an upcoming time based on the estimated one or more poses, thereby preventing the user from falling while the user is immersed in the VR session.

In an exemplary embodiment, the one or more open poses of the user are estimated at a time interval of 1 second, 2 seconds, 3 seconds, 4 seconds, and 5 seconds. The estimated one or more poses are correlated via a Recurrent Neural Network (RNN) algorithm to predict or determine the activity of the user at 6 seconds.

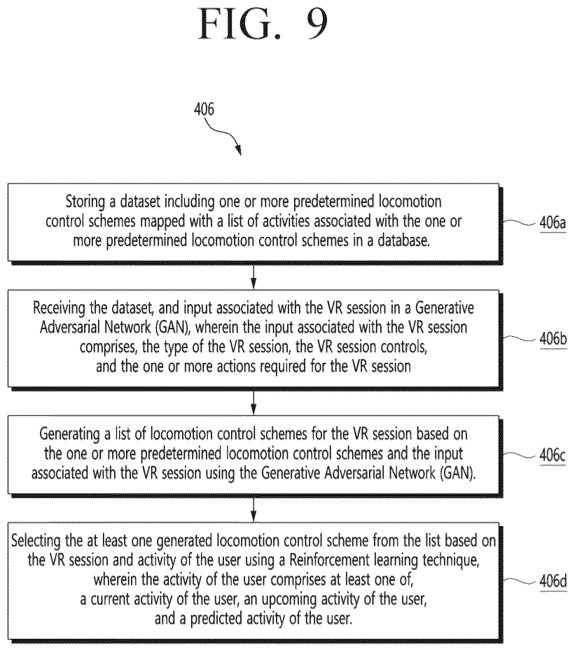

Now again referring to FIG. 4, at operation 406, the method 400 may include generating, via the locomotion control scheme generating module 308, at least one locomotion control scheme (LC) for the user based on the determined safe zone (SZ), the characteristics associated with the user, and the VR session, thereby providing the virtual locomotion control to the user. The characteristics associated with the user may include at least one of, the position of the user and the posture of the user. In one or more embodiments, the generation of the locomotion control scheme (LC) is explained in conjunction with FIG. 9.

FIG. 9 illustrates a flowchart depicting a operation 406 for generating at least one locomotion control scheme (LC) for the user, in accordance with one or more embodiments of the present disclosure. At sub-operation 406a, the operation 406 may include storing a dataset including one or more predetermined locomotion control schemes (LCs) mapped with a list of activities associated with the one or more predetermined locomotion control schemes in the database 108.

In an exemplary embodiment, the one or more predetermined locomotion control schemes (LCs) and the list of activities are shown in Table 2 below:

TABLE 2
Dataset

| Stored Locomotion control schemes | List of Activities |
|---|---|
| Treadmill | Walking, Running |
| Trampoline | Jumping, Projectile |
| Hoverboard | Bending, running |

At sub-operation 406b, the operation 406 may include receiving the dataset, and input associated with the VR session in a Generative Adversarial Network (GAN). The input associated with the VR session may include the type of the VR session, the VR session controls, and the one or more actions required for the VR session.

At sub-operation 406c, the operation 406 may include generating a list of locomotion control schemes (LCs) based on the one or more predetermined locomotion control schemes (LCs) and the input associated with the VR session using the Generative Adversarial Network (GAN).

TABLE 3

| Generated Locomotion control schemes | Activities |
|---|---|
| Stepper | Walking, Running |
| Leg Swing | Jumping, Projectile |
| Slingshot | Projectile |

In one or more embodiments of the present disclosure, the stored one or more predetermined locomotion control schemes (LCs), and the list of locomotion control schemes (LCs) generated via a Generation network, are transmitted to a Discriminator Network. The Discriminator Network is adapted to generate an augmented list of generated virtual locomotion schemes.

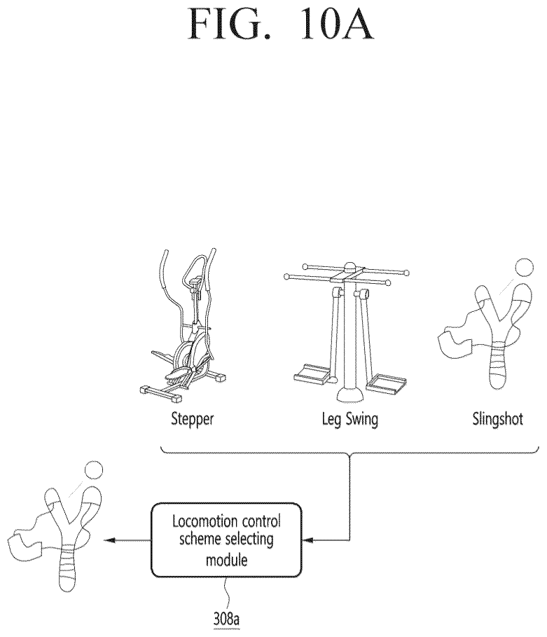

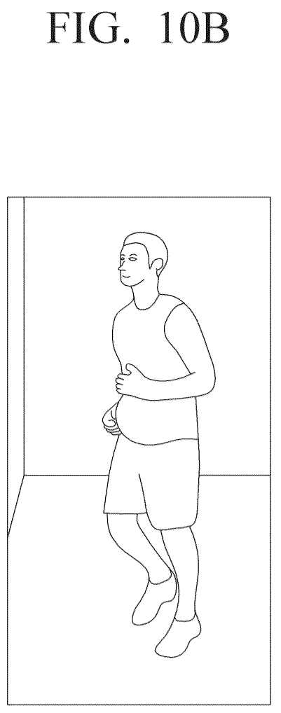

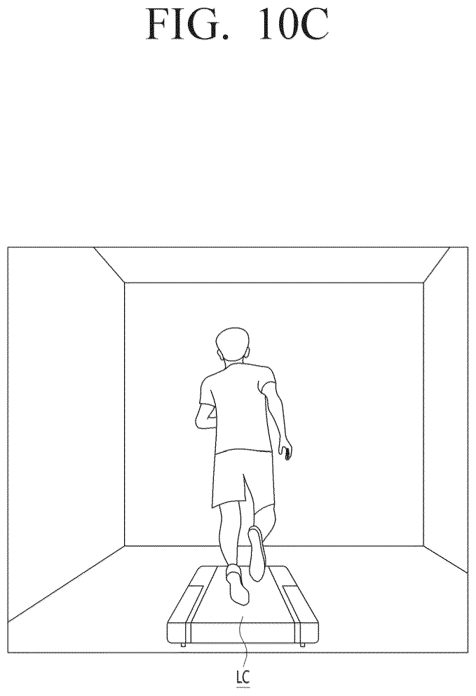

At sub-operation 406d, the operation 406 may include selecting, via the locomotion control scheme generating sub-module 308a, the at least one generated locomotion control scheme (LC) from the list of the generated locomotion control schemes (LCs) based on the VR session and activity of the user as illustrated in FIG. 10A. The activity of the user may include at least one of, a current activity of the user, an upcoming activity of the user, and the predicted activity of the user. In one or more embodiments of the present disclosure, the at least one generated locomotion control scheme is selected by utilizing a Reinforcement learning technique which is a Reinforcement locomotion control scheme selection technique. In one or more embodiments, the Reinforcement learning technique works best for models that need continuous learning. In the VR session, the VR environment, physical environment, user conditions, and a number of users vary continuously. Therefore, the reinforcement learning technique-based decision-making algorithm is well-suited for selecting an optimum locomotion control scheme from the list of generated locomotion control schemes and fed to the user interfacing module 310 to overlay into the field of View (FOV) of the user.

FIG. 10A illustrates an exemplary representation of a selection of the at least one generated locomotion control scheme (LC), in accordance with one or more embodiments of the present disclosure. In an exemplary embodiment, the predetermined one or locomotion control schemes (LCs) such as a treadmill, a trampoline, and a hoverboard are obtained from the database 108 as illustrated in Table 2, based on this, the list of locomotion control schemes (LCs) is generated as illustrated in Table-3. Thereafter, a slingshot is selected as the locomotion control scheme (LC) that is optimum for an exemplary VR session by utilizing the Reinforcement learning technique.

The Reinforcement learning technique receives the list of generated locomotion control schemes for iteration based on feedback using classifier 1 and classifier 2. The iterated results from the classifier 1 and the classifier 2 are compared for selection of the at least one generated locomotion scheme from the list of the generated locomotion control schemes (LCs) based on the VR session and the activity of the user.

For example, three locomotion control schemes are generated and these locomotion control schemes are classified in the Reinforcement learning technique the based on a percent value. For example, a first locomotion control scheme is classified as 37% relevant for the VR session, a second locomotion control scheme is classified as 75% relevant for the VR session, and a third locomotion control scheme is 80% relevant for the VR session, and based on the classification, the optimum locomotion control scheme is selected i.e., the third locomotion control scheme with 80% relevancy.

However, it should be understood that a utilization of the reinforcement learning technique for selection of the at least one locomotion control scheme (LC) should not be construed as a limitation of the present disclosure. In one or more embodiments, other learning techniques may also be utilized for the selection of the at least one locomotion control scheme (LC) for the VR session.

FIGS. 10B and 10C illustrate exemplary representations of the movement of the user in the user physical space and a corresponding movement of the user in the VR session by utilizing the at least one generated locomotion control scheme (LC), in accordance with one or more embodiments of the present disclosure. In an exemplary embodiment of the present disclosure, for the VR session that requires running, a virtual treadmill is generated which is utilized as the at least one generated locomotion control scheme (LC) for providing the virtual locomotion control to the user.

At operation 408, the method 400 may include providing a training interface, via the user interfacing (UI) module 310, to the user, to sync motion between the virtual locomotion control and the VR session control. The training interface may enable the user to perform at least a body movement in the user physical space to generate different activities in the VR session by utilizing the at least one generated locomotion control scheme (LC). The user may move/run in infinite virtual space with little movement in the user physical space, thereby preventing the user from colliding with the one or more obstacles such as the walls or any other objects present in the user physical space. In an exemplary embodiment, the VR session involves running/walking or movement of the legs. In this scenario, the user may be required to run in a same spot within the determined safe zone.

In one or more embodiments, the exemplary movement of the user and a corresponding movement is illustrated in Table 4 below:

TABLE 4

| User Movement in the user physical space | Virtual Session Movement |
|---|---|
| Moving Leg | Running/walking |
| Moving Hand | Projectile motion |
| Tilting left/right | Perform turning motion |

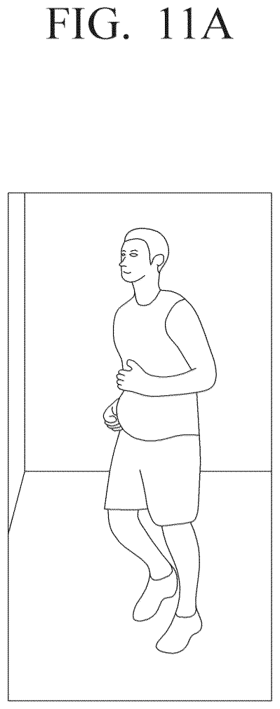

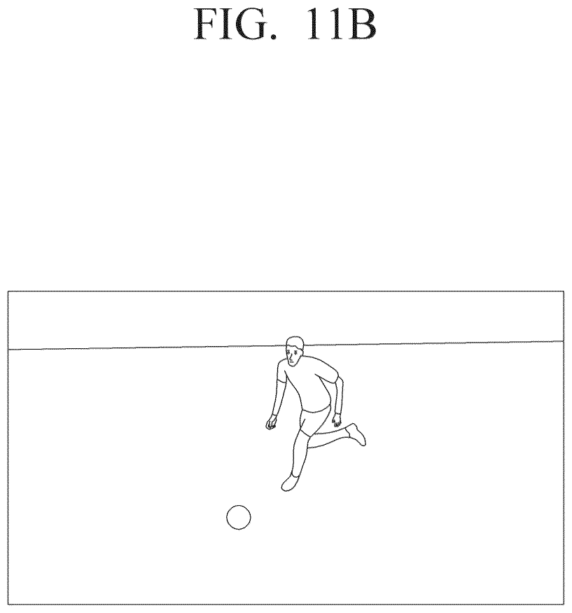

FIGS. 11A and 11B illustrate exemplary representations of the movement of the user in the user physical space and a corresponding movement in the VR session, in accordance with one or more embodiments of the present disclosure.

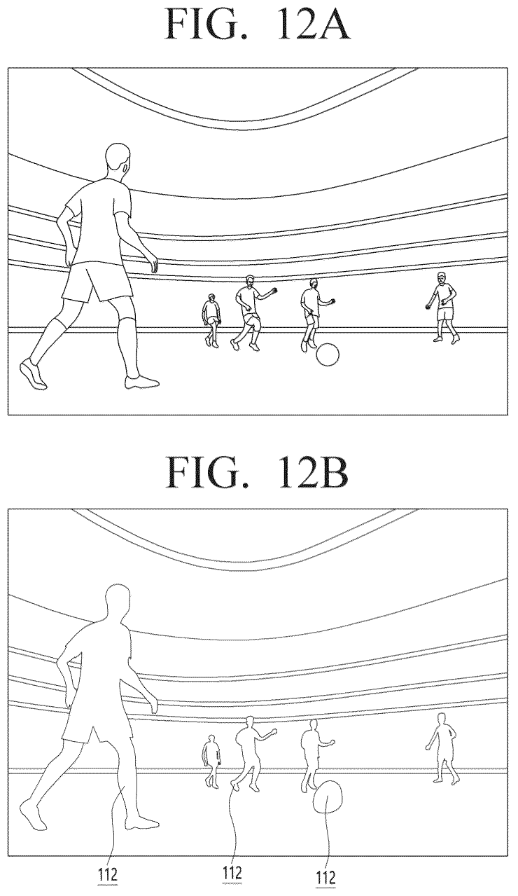

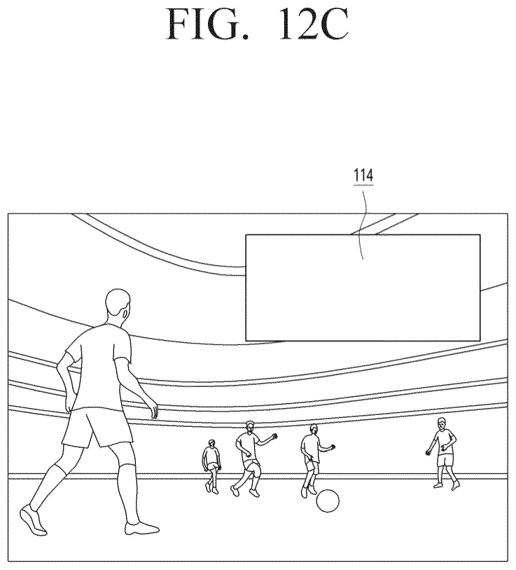

Now, again referring to FIG. 7, at operation 410, the method 400 may include determining a field of view (FOV) of the user in the VR session as illustrated in FIG. 12A.

FIG. 12A illustrates an exemplary representation of the field of view (FOV) of the user while the user is immersed in the VR session, in accordance with one or more embodiments of the present disclosure.

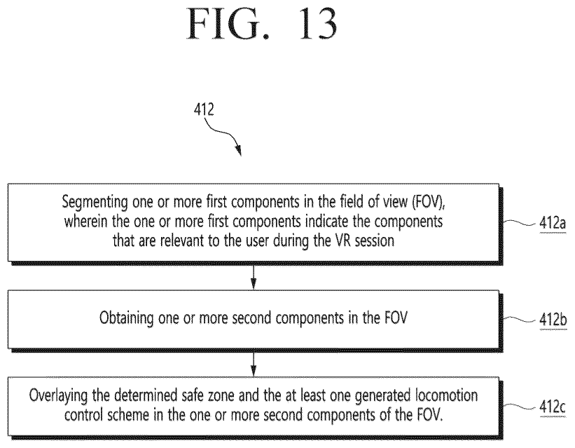

At operation 412, the method 400 may include overlaying, via the overlaying sub-module 310a, the determined safe zone (SZ) and the at least one generated locomotion control scheme (LC) in the field of view (FOV) while the user is immersed in the VR session. More particularly, the overlaying of the determined safe zone (SZ) and the at least one generated locomotion control scheme (LC) in the field of view (FOV) is discussed in conjunction with FIG. 13 and FIGS. 12B-12C.

FIG. 13 illustrates an operation 412 for overlaying the determined safe zone (SZ) and the at least one generated locomotion control scheme (LC) in the FOV of the user, in accordance with one or more embodiments of the present disclosure. At sub-operation 412a, the operation 412 may include segmenting one or more first components 112 in the FOV. The one or more first components 112 indicate the components that are relevant to the user during the VR session. The one or more first components 112 may include other players, a playground, or the like as illustrated in FIG. 12B.

At sub-operation 412b, the operation 412 may include obtaining one or more second components 114 in the FOV. The one or more second components 114 indicate an area that is not relevant to the user during the VR session as illustrated in FIG. 12C.

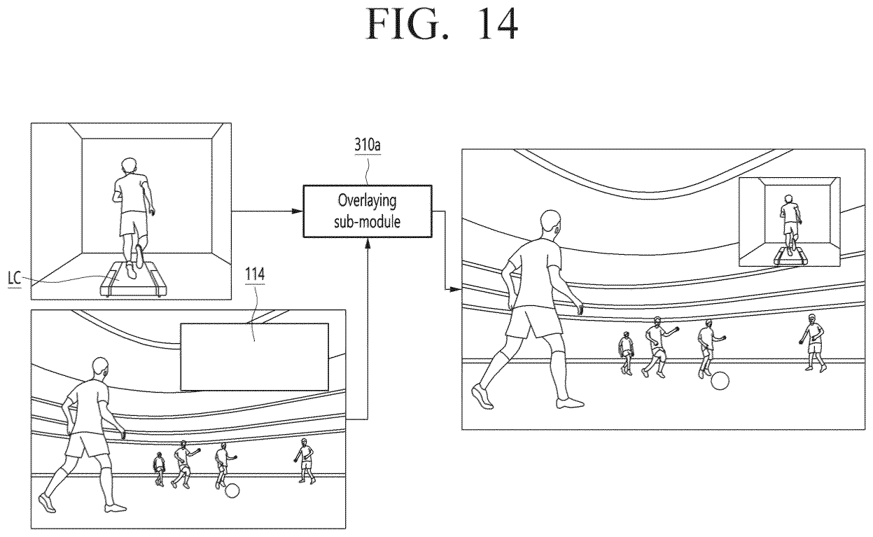

At sub-operation 412c, the method 400 may include overlaying the determined safe zone (SZ) and the at least one generated locomotion control scheme (LC) in the one or more second components of the FOV also illustrated in FIG. 14.

FIG. 14 illustrates an exemplary representation of the overlaying of the determined safe zone (SZ) and the at least one generated locomotion control scheme (LC), in accordance with one or more embodiments of the present disclosure. In an exemplary embodiment, the user may be enabled to see his/her position in real-time and avoid colliding with the one or more obstacles or the one or more walls in the user physical space.

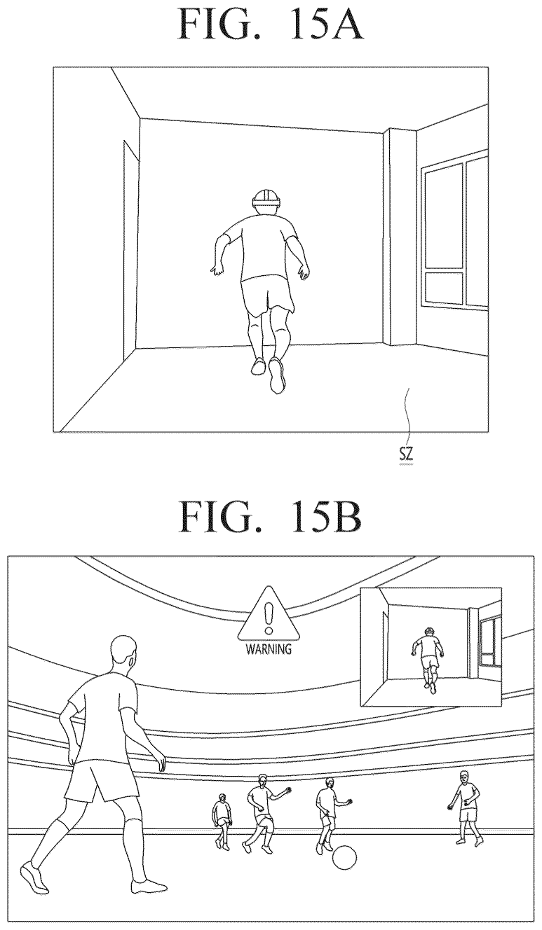

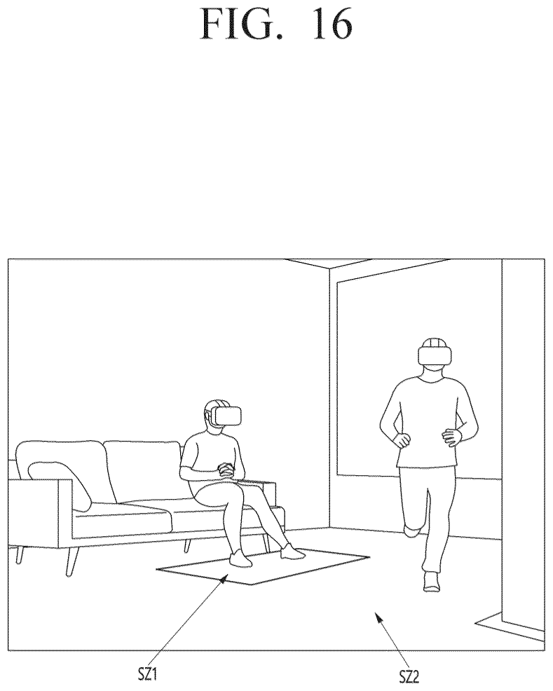

Now again referring to FIG. 7, at operation 414, the method 400 may include generating, via the alert notification generating sub-module 310b, the alert notification when the user crosses the boundary of the determined safe zone (SZ) as illustrated in FIG. 15A and FIG. 15B.

FIG. 15A illustrates an exemplary representation of a user interface depicting the user crossing the determined safe zone, in accordance with one or more embodiments of the present disclosure. FIG. 15B illustrates an exemplary representation of the user interface depicting the generation of the alert notification when the user crosses the boundary of the determined safe zone.

At operation 416, the method 400 may include freezing the VR session when the user is at a predefined threshold distance from a boundary of the floor area as illustrated in FIG. 7.

In one or more embodiments, the present disclosure is explained with reference to one user. However, it should not be construed as a limitation of the present disclosure. In one or more embodiments, more than one user may also be immersed in the VR session in the user physical space.

In an exemplary embodiment, a user A and a user B may be immersed in the VR session in a same Internet of Things (IoT) environment. The user A may select a racing game, and the user B may select soccer. Therefore, the disclosed method 400 and the system 1000 may enable determining the safe zone (SZ) based on the VR session selected by the user A and user B. In one or more embodiments, the user A with the VR session of the racing game may require less space in the user physical space thus, the system 1000 may allocate less space to the user A. Conversely, the user B, while present in the similar user physical space or within the same IoT environment, who selects soccer as the VR session may require more space. Thus, the system 1000 may allocate more space to the user B for immersing in the VR session as compared to the user A. The same is illustrated in Table 5 and FIG. 16.

TABLE 5

| User A | User B |
|---|---|
| VR session: Racing Game | VR session: Soccer |
| Movement Prediction: Sitting, | Movement Prediction: Continuous |
| Neck, and Hand Movement | Running and Kicking |
| Space Required: 20% | Space Required: 80% |

FIG. 16 illustrates an exemplary representation of the user physical space in which two users are immersed in different VR sessions, in accordance with one or more embodiments of the present disclosure. In an exemplary embodiment, the user A selects the racing game as the VR session, and accordingly, a first safe zone (SZ1) is determined based on the space required for the VR session, and therefore, less space is allocated to the user A. Further, the user B selects soccer as the VR session, and accordingly a second safe zone (SZ2) is determined based on the space required for the VR session, henceforth more space is allocated to the user B when the user B is present in the same physical space with the user A as illustrated in FIG. 16.

In another exemplary embodiment, the user A and the user B may select a VR session that requires a similar type of movement and both the user A and the user B are present in the same user physical space. More particularly, the user A selects jogging as the VR session and the user B selects soccer as the VR session, and both VR sessions require similar type of movements in the VR session such as running. Therefore, each of the user A and the user B is allocated with about equal amount of space also referred to as the determined safe zone in the same physical space as illustrated in Table 6.

TABLE 6

| User A | User B |
|---|---|
| VR session: Jogging | VR session: Soccer |
| Movement Prediction: Running | Movement Prediction: Continuous |
| | Running and Kicking |
| Space Required: 50% | Space Required: 50% |

The method 400 and the system 1000 described herein enable generation of the at least one locomotion control scheme (LC), thereby providing the virtual locomotion control to the user. Therefore, this may eliminate the usage of the hardware locomotive devices, thereby enabling the method 400 and the system 1000 to be cost-effective.

The disclosed method 400 enables the user to immerse in the VR session seamlessly without being much affected by the user physical space. The method 400 enables the user to immerse in the VR session in a constrained environment.

Further, the method 400 and the system 1000 of the present disclosure may allow the user to perform a few body movements to generate different activities in the VR session by utilizing the at least one generated locomotion control scheme (LC).

Furthermore, the method 400 and the system 1000 may prevent motion sickness as the user may correlate the movement in the user physical space with the movement in the VR session, even if the user doesn't perform the exact motion.

Moreover, the method 400 and the system 1000 of the present disclosure enhance user experience as the virtual locomotion control creates a more immersive experience.

In addition, the disclosed method 400 and the system 1000 enable the user with a disability to immerse in the VR session seamlessly by designing specialized locomotion controls for the user with the disability.

Further, the disclosed method 400 and the system 1000 enable multiple users to get immersed in the VR sessions seamlessly without being much affected by any other users present in the user physical space or any obstructions nearby.

Moreover, the present disclosure doesn't affect the VR session and maintains original and nonstop enablement of the VR session, thereby enhancing the user experience.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

According to one or more embodiments of the disclosure, various examples described above may be implemented as software including instructions stored in a machine (e.g. computer) readable storage medium. The machine refers to a device which calls instructions stored in the storage medium and is operable according to the called instructions, wherein the machine may include an electronic device (e.g. an electronic device A) according to the disclosed embodiments. If the instructions are executed by a processor, the processor may perform a function corresponding to the instructions directly or by using other components under control of the processor. The instructions may include a code generated or executed by a compiler or an interpreter. A machine readable storage medium may be provided in a form of a non-transitory storage medium. Here, the term ‘non-transitory’ merely means that the storage medium does not include a signal and is tangible, wherein the term does not distinguish a case that data is stored in the storage medium semipermanently from a case that data is stored in the storage medium temporarily.

Also, according to one or more embodiments of the disclosure, the method according to various examples described above may be provided to be included in a computer program product. The computer program product may be traded between a seller and a buyer as goods. The computer program product may be distributed in a form of a machine readable storage medium (e.g. compact disc read only memory (CD-ROM)) or may be on-line distributed via an application store (e.g. Play-Store™). In the case of on-line distribution, at least part of the computer program product may be stored at least temporarily or may be generated temporarily in a storage medium such as memory of a server of a manufacturer, a server of an application store, or a relay server.

Also, according to one or more embodiments of the disclosure, one or more embodiments described as above may be implemented in a recording medium that may be read by a computer or a device similar thereto by using software, hardware, or a combination thereof. In some cases, the embodiments described in the specification may be implemented as a processor itself. According to software implementation, the embodiments such as procedures and functions described in the specification may be also implemented as separate software. Each software may perform one or more functions and operations described in the specification.

Computer instructions for performing the processing operation of the machine according to the one or more embodiments above may be stored in a non-transitory computer readable medium. The computer instructions stored in this non-transitory computer readable medium, when executed by a processor of a specific device, causes the specific device to perform a processing operation of the device according to the one or more embodiments. The non-transitory computer readable medium does not mean a medium that stores data for a short time such as a resistor, a cache, memory, or the like but means a machine readable medium that stores data semipermanently. A specific example of the non-transitory computer readable medium may be a CD, a DVD, a hard disk, a Blu-ray disk, a USB, a memory card, ROM, etc.

What is claimed is:

1. A method of providing virtual locomotion control to a user during a virtual reality (VR) session, the method comprising:
capturing one or more frames of a user physical space;
determining a safe zone within the user physical space based on the one or more frames;
generating at least one locomotion control scheme for the user based on the safe zone, at least one characteristic associated with the user, and the VR session; and
providing the virtual locomotion control to the user based on the at least one locomotion control scheme.

2. The method of claim 1, wherein the at least one characteristic associated with the user comprises at least one of a position of the user and a posture of the user.

3. The method of claim 1, wherein the determining the safe zone within the user physical space further comprises:
generating a panoramic image based on merging the one or more frames, wherein the one or more frames comprise images of the user physical space;
identifying one or more elements of the user physical space, wherein the one or more elements comprises one or more of an obstacle, a traversable area, one or more other users, and one or more walls within the user physical space; and
mapping a boundary around the one or more elements of the user physical space.

4. The method of claim 3, wherein the user physical space is determined based on the panoramic image.

5. The method of claim 1 wherein the determining the safe zone further comprises:
receiving a user input indicating a distance of one or more obstacles from a position of the user; and
determining the safe zone based on the user input.

6. The method of claim 1, wherein the VR session includes immersion of the user in a three-dimensional (3D) virtual environment and further includes interaction with an object or an entity in the 3D virtual environment, and
wherein the VR session comprises a type of the VR session, one or more VR session controls, and one or more locomotion options within the VR session.

7. The method of claim 1, wherein the generating the at least one locomotion control scheme for the user comprises:
storing, in a database, a dataset comprising one or more predetermined locomotion control schemes mapped with a list of activities associated with the one or more predetermined locomotion control schemes;
inputting the dataset and input associated with the VR session into a generative adversarial network (GAN), wherein the input associated with the VR session comprises one or more of a type of the VR session, a VR session control, and one or more locomotion options within the VR session;
generating, using the GAN, a list of locomotion control schemes for the VR session; and
selecting the at least one locomotion control scheme from the list of locomotion control schemes based on the VR session and an activity of the user using a reinforcement learning technique,
wherein the activity of the user comprises at least one of a current activity of the user, an upcoming activity of the user, and a predicted activity of the user.

8. The method of claim 1, further comprising:
overlaying the safe zone and the at least one locomotion control scheme in a field of view of the VR session while the user is immersed in the VR session.

9. The method of claim 1, further comprising:
based on the user crossing a boundary of the safe zone, generating an alert notification; or
based on the user being a predefined threshold distance from a boundary of a floor area, freezing the VR session.

10. The method of claim 1, further comprising:
providing a training interface to the user, wherein the training interface is configured to sync motion between the virtual locomotion control and a VR session control.

11. The method of claim 1, wherein the safe zone is allocated to each of a plurality of users including the user, in the user physical space, based on respective VR sessions of each of the plurality of users.

12. A system for providing virtual locomotion control to a user during a virtual reality (VR) session, the system comprising:
a sensor;
a memory storing one or more instructions; and
at least one processor configured to execute the one or more instructions,
wherein the one or more instructions, when executed by the at least one processor, cause the system to:
obtain, through the sensor, one or more frames of a user physical space;
determine a safe zone within the user physical space;
generate at least one locomotion control scheme for the user based on the safe zone, at least one characteristic associated with the user, and the VR session; and
provide the virtual locomotion control to the user based on the at least one locomotion control scheme.

13. The system of claim 12, wherein the at least one characteristic associated with the user comprises at least one of a position of the user and a posture of the user.

14. The system of claim 12,
wherein the sensor comprises a camera, and
wherein one or more instructions, when executed by the at least one processor, cause the system to determine the safe zone by:
generating a panoramic image based on merging the one or more frames, wherein the one or more frames comprise images of the user physical space;
identifying one or more elements of the user physical space, wherein the one or more elements comprise one or more of an obstacle, one or more other users, a traversable area, and one or more walls within the user physical space; and
mapping a boundary around the one or more elements of the user physical space.

15. The system of claim 14, wherein the user physical space is determined based on the panoramic image.

16. A non-transitory computer readable medium having instructions stored therein, which when executed by at least one processor cause the at least one processor to execute a method of providing virtual locomotion control to a user during a virtual reality (VR) session, the method comprising:
capturing one or more frames of a user physical space;
determining a safe zone within the user physical space based on the one or more frames;
generating at least one locomotion control scheme for the user based on the safe zone, at least one characteristic associated with the user, and the VR session; and
providing the virtual locomotion control to the user based on the at least one locomotion control scheme.

17. The non-transitory computer readable medium of claim 16, wherein the determining the safe zone within the user physical space further comprises:
generating a panoramic image based on merging the one or more frames, wherein the one or more frames comprise images of the user physical space;
identifying one or more elements of the user physical space, wherein the one or more elements comprise one or more of an obstacle, a traversable area, one or more other users, and one or more walls within the user physical space; and
mapping a boundary around the one or more elements of the user physical space.

18. The non-transitory computer readable medium of claim 17, wherein the user physical space is determined based on the panoramic image.

19. The non-transitory computer readable medium of claim 16, wherein the generating the at least one locomotion control scheme for the user comprises:
storing, in a database, a dataset comprising one or more predetermined locomotion control schemes mapped with a list of activities associated with the one or more predetermined locomotion control schemes;
inputting the dataset and input associated with the VR session into a generative adversarial network (GAN), wherein the input associated with the VR session comprises one or more of a type of the VR session, a VR session control, and one or more locomotion options within the VR session;
generating, using the GAN, a list of locomotion control schemes for the VR session; and
selecting the at least one locomotion control scheme from the list of locomotion control schemes based on the VR session and an activity of the user using a reinforcement learning technique,
wherein the activity of the user comprises at least one of a current activity of the user, an upcoming activity of the user, and a predicted activity of the user.

20. The non-transitory computer readable medium of claim 16, wherein the method further comprises:
based on the user crossing a boundary of the safe zone, generating an alert notification; or
based on the user being a predefined threshold distance from a boundary of a floor area, freezing the VR session.
